(19) United States
(12) Patent Application Publication
(10) Pub. No.: US 2023/0195214 A1
(43) Pub. Date: Jun. 22, 2023

(54) PRESENTATION OF ELECTRONIC CONTENT ACCORDING TO DEVICE AND HEAD ORIENTATION

(71) Applicant: Lenovo (Singapore) Pte. Ltd., Singapore (SG)

(72) Inventors: Matthew Tucker, Chapel Hill, NC (US); Brian Leonard, Chapel Hill, NC (US)

(21) Appl. No.: 17/555,157

(22) Filed: Dec. 17, 2021

(51) Int. Cl. G06F 3/01; G06F 1/16; G06T 7/70; H04W 4/80

(52) U.S. Cl. CPC G06F 3/012; G06F 1/163; G06F 1/1686; G06F 1/1694; G06T 7/70; H04W 4/80

(57) ABSTRACT

In one aspect, a smart watch or other device may include at least one processor, a display accessible to the at least one processor, and storage accessible to the at least one processor. The storage may include instructions executable by the at least one processor to identify an orientation of a user’s head and identify an orientation of the smart watch with respect to the user’s head. The instructions may also be executable to, based on the orientation of the user’s head and the orientation of the smart watch, present content on the display in a content orientation that is maintained with respect to a reference for the content to appear upright on the display relative to the reference.

### FIELD

The disclosure below relates to technically inventive, non-routine solutions that are necessarily rooted in computer technology and that produce concrete technical improvements. In particular, the disclosure below relates to techniques for presentation of electronic content according to device and head orientation.

### BACKGROUND

As recognized herein, smart watches on the market today do not rotate the content they present and instead present their content statically, which is far from ideal ergonomically speaking since being able to read the content can involve significant arm movement on the part of the user. As also recognized herein, even where other device types alternate between portrait and landscape orientations, such orientations do not work well for smart watches since presenting content in those orientations would still result in a user being unable to clearly read the content in many instances where the user is not looking directly at the smart watch upright and straight in front of their face. These issues are further compounded by the types of complex content that modern smart watches can present rather than the simple time of day presentation that many traditional watches use. There are currently no adequate solutions to the foregoing computer-related, technological problem.

### SUMMARY

Accordingly, in one aspect a smart watch includes at least one processor, a display accessible to the at least one processor, and storage accessible to the at least one processor. The storage includes instructions executable by the at least one processor to identify an orientation of a user’s head and to identify an orientation of the smart watch with respect to the user’s head. The instructions are also executable to, based on the orientation of the user’s head and the orientation of the smart watch, present content on the display in a content orientation that is maintained with respect to a reference for the content to appear upright on the display relative to the reference.

Thus, in various example implementations the reference may be the user’s line of sight to the display as determined from the orientation of the user’s head, and the content orientation may be a twelve o′clock orientation with respect to the user’s line of sight.

Additionally, in various examples the smart watch may include a camera accessible to the at least one processor, and the instructions may be executable to receive input from the camera and identify the orientation of the user’s head based on the input from the camera. For example, the instructions may be executable to identify an orientation of a body part of the user besides the user’s head based on the input from the camera and to deduce the orientation of the user’s head based on the orientation of the body part. The instructions may also be executable to identify the orientation of the smart watch based on the input from the camera.

Also in various examples, the smart watch may include at least one motion sensor accessible to the at least one processor, and the instructions may be executable to identify the orientation of the user’s head based on input from the at least one motion sensor. For example, the instructions may be executable to identify movement of the smart watch based on input from the at least one motion sensor and to identify the orientation of the user’s head based on the movement of the smart watch. As another example, the instructions may be executable to identify an activity of the user based on input from the at least one motion sensor and to identify the orientation of the user’s head based on the activity of the user.

Still further, in some examples the smart watch may include an ultra-wideband (UWB) transceiver accessible to the at least one processor, and the instructions may be executable to use the UWB transceiver to receive one or more first UWB signals from a device different from the smart watch and then identify the orientation of the user’s head based on the one or more first UWB signals. If desired, the instructions may also be executable to use the UWB transceiver to receive one or more second UWB signals from the device and identify the orientation of the smart watch based on the one or more second UWB signals. The one or more second UWB signals may be the same as or different from the one or more first UWB signals.

In another aspect, a method includes identifying an orientation of a user’s head and, based on the orientation of the user’s head, presenting content on the display of a device in a content orientation that is maintained with respect to a reference for the content to appear upright on the display relative to the reference.

Thus, in some examples the method may include identifying an orientation of the device with respect to the user’s head and, based on the orientation of the user’s head and the orientation of the device, presenting the content on the display in the content orientation to appear upright on the display relative to the reference.

In various example implementations, the reference may a direction in which the user’s face is oriented as determined from the orientation of the user’s head, and the content orientation may be a twelve o′clock orientation with respect to the direction in which the user’s face is oriented.

Additionally, if desired the method may include determining the orientation of the user’s head based on input from a camera, input from a motion sensor, and/or input from an ultra-wideband (UWB) transceiver.

In still another aspect, a device includes a housing, a display on the housing and configured to electronically present a content presentation, an orientation sensor configured to sense an angular orientation of the housing, and at least one processor programmed with instructions to receive signals from the orientation sensor and in response thereto rotate the content presentation on the display to a first angular orientation relative to a reference.

In various examples, the first angular orientation may be a predetermined orientation, and the instructions may be executable to maintain the content presentation in the first angular orientation as the housing turns.

If desired, the first angular orientation may include a twelve o′clock orientation. Also, if desired, the reference may include a location of a wearer of the device. Still further, the orientation sensor may include a camera, an inertial measurement unit (IMU), and/or an ultra-wideband (UWB) transceiver.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3 and 4 show illustrations of content presented on a smart watch at various orientations based a user’s head orientation with respect to the watch consistent with present principles;

FIG. 5 illustrates example logic in example flow chart format that may be executed by a device consistent with present principles; and

FIG. 6 shows an example graphical user interface (GUI) that may be presented to configure one or more settings of the smart watch to operate consistent with present principles.

### DETAILED DESCRIPTION

Among other things, the detailed description below discusses devices and methods for rotating display content on a smart watch or other type of device with respect to the watch hardware, such that wherever the user’s arm is in relation to their eyes, the screen content appears level for maximum readability. For example, if the user holds their left arm straight out in front of them and rotates their wrist so that the watch is face-up, the content may rotate so the top of the content is closest to the user’s hand and the bottom of the content is closest to the user’s torso. Thus, content as presented on the watch’s display may be oriented to be level with the user’s view regardless of arm position. Thus, the smart watch may allow screen angle adjustments not necessarily in in full 90-degree increments but at more fine angles on a degree-by-degree basis as driven by the orientation to the user or another reference, not only by the orientation of the device itself.

Accordingly, the content may be maintained in a twelve o′clock orientation with respect to the reference so that a vector from the center of the content to the “12” position points directly away from the reference. The reference could be the center of the earth in the vertical plane or the location of the user in the horizonal plane.

Further note that present principles may be applied not just to watches (e.g., round watches, square watches, and other shapes) but to other devices as well, including other types of wearable devices with display screens as well as implantable skin devices with display screens and still other types of devices.

Additionally, note that if content is rotated for a rectangular smart watch such that the corners of the content presentation might be cut off when rotated, the content may either be resized so that it still all fits within the display according to the rotation, or the corners of the content may be cutoff and not presented.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM, or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

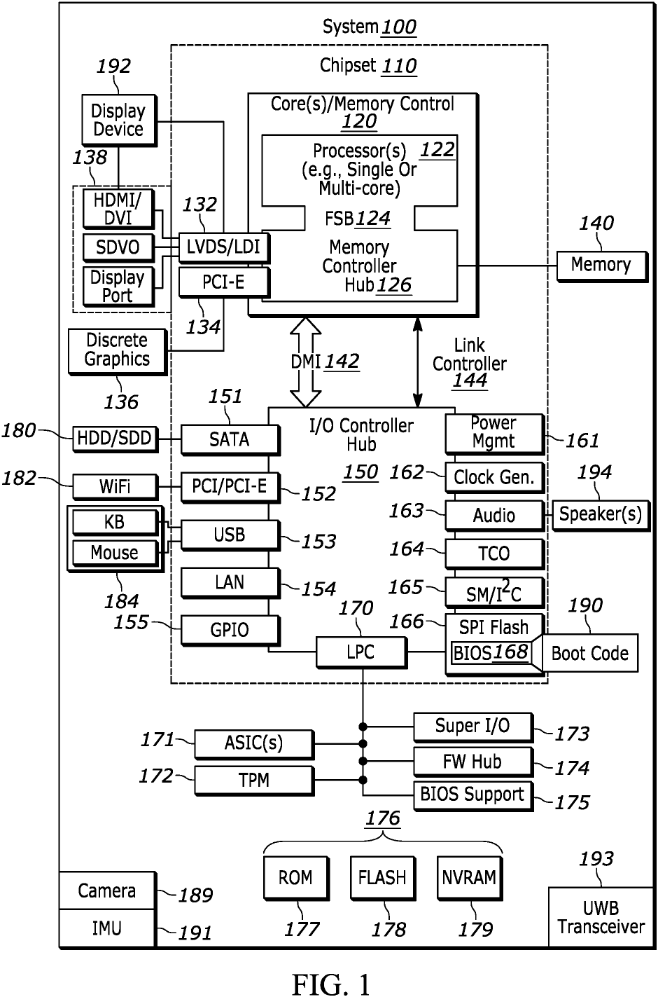

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, which are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include a camera 189 that gathers one or more images and provides the images and related input to the processor 122. The camera 189 may be a thermal imaging camera, an infrared (IR) camera, a digital camera such as a webcam, a three-dimensional (3D) camera, and/or a camera otherwise integrated into the system 100 and controllable by the processor 122 to gather still images and/or video consistent with present principles (e.g., to determine a head orientation of a user).

Still further, the system 100 may include an inertial measurement unit (IMU) 191 that itself may include motion sensors like one or more accelerometers, gyroscopes, and/or magnetometers that may sense movement and/or orientation of the system 100 and provide related input to the processor(s) 122. More specifically, the IMU’s gyroscope may sense and/or measure orientation of the system 100 as well as orientation changes and provide related input to the processor 122, the IMU’s accelerometer may sense acceleration and/or movement of the system 100 and provide related input to the processor 122, and the IMU’s magnetometer may sense the strength of a magnetic field and/or dipole moment to then provide related input to the processor 122 (e.g., to determine the system 100′s heading and/or direction relative to the Earth’s magnetic field as the system 100 moves).

As also shown in FIG. 1, the system 100 may include an ultra-wideband (UWB) transceiver 193 for user/device orientation determinations and location tracking consistent with present principles. The UWB transceiver 193 may be configured to transmit and receive data using UWB signals and UWB communication protocol(s), such as protocols set forth by the FiRa Consortium. As understood herein, UWB may use low energy, short-range, high-bandwidth pulse communication over a relatively large portion of the radio spectrum. Thus, for example, an ultra-wideband signal/pulse may be established by a radio signal with fractional bandwidth greater than 20% and/or a bandwidth greater than 500 MHz. UWB communication may occur by using multiple frequencies (e.g., concurrently) in the frequency range from 3.1 to 10.6 GHz in certain examples.

To transmit UWB signals consistent with present principles, the transceiver 193 itself may include one or more Vivaldi antennas and/or a MIMO (multiple-input and multiple-output) distributed antenna system, for example. It is to be further understood that various UWB algorithms, time difference of arrival (TDoA) algorithms, and/or angle of arrival (AoA) algorithms may be used for system 100 to determine the distance to and location of another UWB transceiver on another device that is in communication with the UWB transceiver 193 on the system 100 to thus track the real-time location of the other device in relatively precise fashion consistent with present principles. The orientation of the system 100 and/or the other device may even be tracked via the UWB signals.

Additionally, though not shown for simplicity, in some embodiments the system 100 may include an audio receiver/microphone that provides input from the microphone to the processor 122 based on audio that is detected, such as via a user providing audible input to the microphone. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

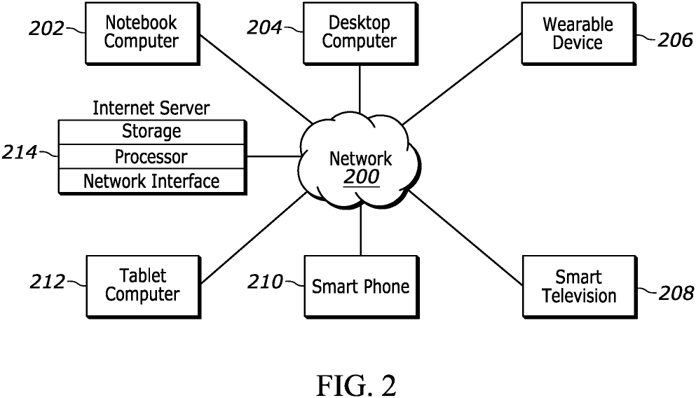

Turning now to FIG. 2, example devices are shown communicating over a network 200 such as the Internet, a Bluetooth network, a UWB network, etc. in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

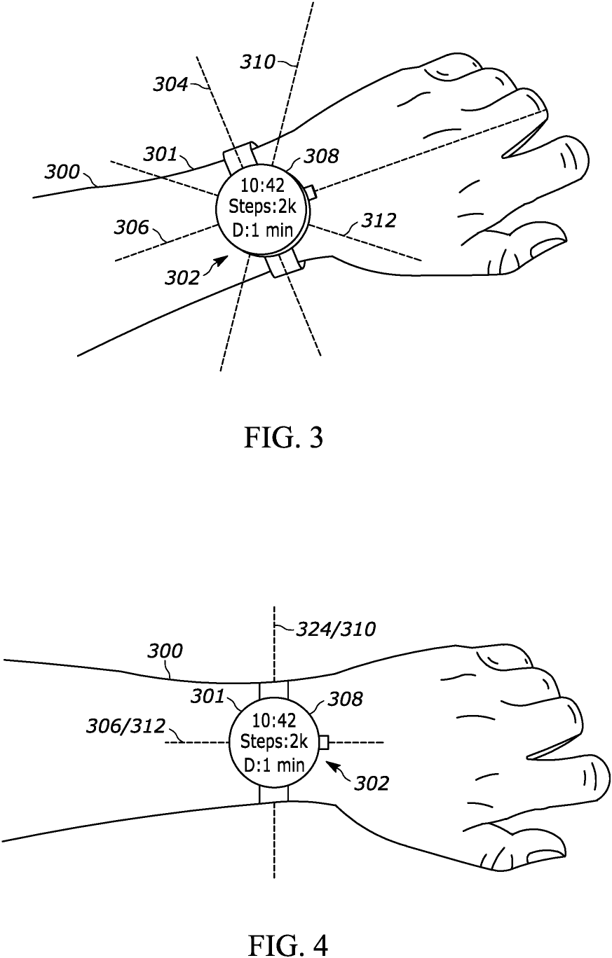

Reference will now be made to FIGS. 3 and 4, which show various examples of a user’s arm 300 being oriented at a certain angle with respect to the orientation of the user’s head. The perspective shown in these figures is to be understood as the perspective/view of the user themselves according to their current head orientation.

As may be appreciated from FIG. 3, the user’s arm 300 is oriented at an oblique X-Y angle from the user’s perspective, and as a result, a smart watch 302 with a housing 301 that has a circular face and houses an electronic display is shown as located on the user’s arm at a particular orientation itself. Thus, as shown in FIG. 3 the housing 301 is oriented in a first angular orientation/position relative to the user’s location (e.g., head location in particular).

As also shown in FIG. 3, while the watch 302 has a longitudinal/first primary axis 304 and a transverse/second primary axis 306, a content presentation 308 that includes content like a time of day, steps walked, and distance walked is not aligned with the axes 304, 306 in that a vertical axis 310 of the content presentation 308 is not aligned with/parallel to the axis 304, and in that a horizontal axis 312 of the content presentation 308 is not aligned with/parallel to the axis 306. Rather, the axis 310 establishes an oblique angle with the axis 304 and the axis 312 also establishes an oblique angle with the axis 306 so that the content presentation 308 is maintained in a particular predetermined angular orientation even as the housing 301 might turn based on movement of the user’s wrist (e.g., so that the content presentation 308 is maintained in a twelve o′clock orientation from the perspective of the user for the user to view the content presentation 308 upright from their perspective).

Turning to FIG. 4, here the user has now oriented the arm 300 so that the arm 300 and hence watch 302 is in a different angular orientation/position relative to the user’s head. Based on the watch 302 detecting this change in orientation of the watch 302 with respect to the user’s head orientation/viewing angle, the content presentation 308 has been rotated so that it is maintained in the twelve-o′clock orientation relative to the user to still appear upright to the user notwithstanding the change in angle. Thus, in the example of FIG. 4 the axes 304 and 310 are now aligned with/parallel to each other, as are the axes 306 and 312 since the user’s arm 300 is now angled horizontally.

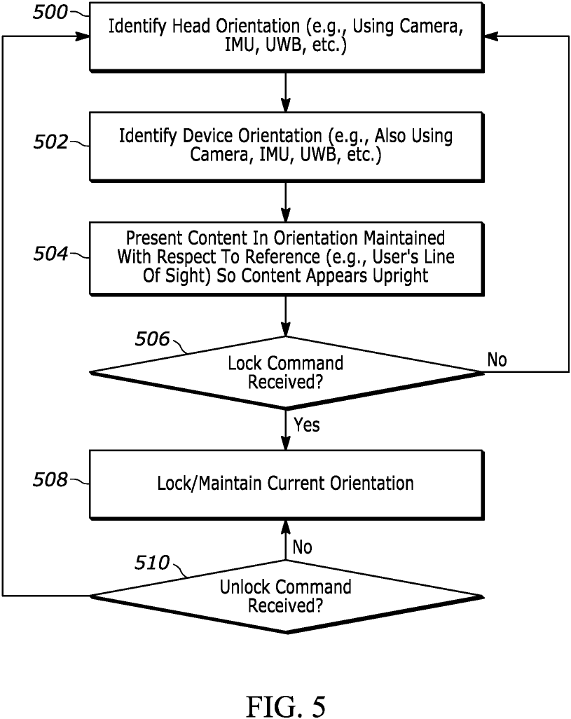

Continuing the detailed description in reference to FIG. 5, it shows example logic that may be executed by a device such as the system 100, the watch 302, a remotely located server, or another type of device (including other wearable devices) alone or in any appropriate combination consistent with present principles. Also note that while the logic of FIG. 5 is shown in flow chart format, other suitable logic may also be used.

Beginning at block 500, the device may identify an orientation of a user’s head to thus identify or deduce the direction that the user’s face is facing in the horizontal plane. Thereafter the logic may proceed to block 502 where the device may identify an orientation of the smart watch or other device with respect to the user’s head to identify or deduce the angular orientation of the device relative to the direction that the user’s face is facing. Detecting orientation according to these two steps may be accomplished multiple ways.

For example, the device may include a camera on its face or integrated into its display in particular, though a camera located on another device that still has the user within its field of view might also be used. Either way, in these examples the device may receive input from the camera and identify the orientation of the user’s head based on the input from the camera. For example, based on the input from the camera, the device may identify an orientation of a body part of the user besides the user’s head, e.g., if the user’s head is not shown in the camera’s field of view. This might include the device identifying a right shoulder of the user, torso of the user, neck of the user, etc. and then based on object recognition of that body part the device may deduce the orientation of the user’s head from the visible portion of the user shown in the camera input by assuming the user’s head is facing the same direction as the rest of the front of their body. Also note that if the user’s head is actually shown in the camera input, the orientation of the user’s head may simply be identified from that. But either way, further note that in these examples the camera input may also be used to identify the orientation of the device/watch with respect to the user’s head based on the viewing angle to the user’s head or other body part as shown in the camera input itself.

Thus, in certain implementations the camera does not necessarily need to see the user’s face but could assess what portion of the user’s body is visible to camera to determine how the device/watch is oriented to the user, and therefore how the device’s display content should be rotated. E.g., if the camera is mounted on the device/watch at the 6:00 o′clock position, with its viewing axis perpendicular to the watch face, and the user holds their left arm with the watch out at a 45-degree angle, the camera might see a small section of the user’s right side. This would inform the device that the user’s arm is at a 45-degree angle, and thus the screen content may be rotated clockwise 45 degrees with respect to the watch hardware/display to align the content level with the user’s view. Thus, in one respect it may be thought of as the device overall assessing how much to the right or left of center the user is from the camera’s field of view to calculate the appropriate content rotation based on that.

As another example for detecting device and head orientation, note that the watch or other device may include one or more motion sensors like a gyroscope and/or accelerometer to, based on input from the motion sensor(s), identify the orientation of the user’s head. E.g., the device may use input from the motion sensor(s) to identify movement of the device itself and then, based on the movement of the device, identify the orientation of the user’s head. This may be done based on the device assuming its location on a left or right arm of the user and also recognizing the device’s movement as being indicative of the user’s head facing a certain direction based on the movement. Certain movements of the device may thus themselves be preprogrammed by the device’s manufacturer or developer as corresponding to certain head orientations. Additionally, or alternatively, a pattern of movement may be identified using the motion sensors to then identify an activity being performed by the user based on the movement (and hence identify head orientation while performing the activity), also based on preprogramming of device movements/movement patterns to predetermined activities.

Thus, according to the motion sensor example the device may periodically or continually assess what direction the user’s body is facing, not necessarily with respect to any external coordinates but in relation to the angle of the watch itself. Thus, if input from the motion sensor indicates the user’s arm swinging back and forth like a pendulum, this motion may be correlated to walking or even running for the device to then make a body-facing angle determination since hand-swinging motions associated with walking or running indicate what direction the user themselves is facing. Driving a vehicle is another example since the user’s head orientation can be deduced from detection of the user’s hand moving a steering wheel to rotate the steering wheel around a fixed axis perpendicular to the user’s body. Other activities may also be tracked to assess what direction the user is facing, and these are but two examples.

Continuing with the motion sensor example, the motion sensor(s) may also be used to determine the orientation of the device itself with respect to the user’s head. This may be done by the device detecting a predetermined “check the time” wrist twist (e.g., as may otherwise be used to active a smart watch display). Detection of this movement may indicate that the user wants to look at the device’s display screen and so the watch may calculate the 3-dimensional axis about which the device rotated. The angle of this axis may be assumed to be the angle of the user’s arm, which implies the angle of the device hardware with respect to the user’s head orientation. Thus, by comparing the user’s head or body-facing direction/angle and the device hardware angle, the device can determine the appropriate screen content rotation angle to align the content horizontal to the user for upright viewing relative to the user’s head orientation.

As yet another example of how the device might identify head orientation and device orientation with respect to the user’s head, an ultra-wideband (UWB) transceiver on the device/watch may be used to communicate via UWB with another device like headphones the user is wearing to receive one or more first UWB signals from the other device and identify the orientation of the user’s head based on the one or more first UWB signals. The device of FIG. 5 may also communicate via UWB with the other device to receive one or more second UWB signals from the other device and identify the orientation of the device/watch of FIG. 5 with respect to the user’s head orientation based on the one or more second UWB signals and the identified head orientation. The one or more second UWB signals may be the same as or different from the one or more first UWB signals.

Thus, the device/watch of FIG. 5 may maintain a UWB connection with the user’s phone, earbuds, or other portable electronic device the user may have. So, for example, if the user has earbud headphones installed in their ears, UWB location and orientation tracking using UWB transceivers on each device may be used to assess the angle between the device/watch hardware and the user’s head (assuming the left/right earbuds have been installed properly to indicate a forward direction assumed to be the direction in which the user is facing). This angle may thus be used as the amount that the watch screen/content should rotate to align with the user’s view.

As another example, UWB transceivers on the device/watch of FIG. 5 and a separate smartphone may be used. E.g., if the user is sitting at a table and the phone is detected as being used to send a text message or to browse the Internet, it can be assumed that phone is being held facing the user and hence the user’s head orientation may be deduced from that. Even if the phone is put down, the device can remember the orientation of the phone when it was being used (as determined via UWB communication), and unless motion is detected at the watch which suggests the user getting up and walking away, rotating their chair, or otherwise altering their head orientation, the determined head orientation/body-facing direction may be assumed as constant. The device can then compare the head orientation to the device’s angle after the user rotates their wrist to activate the screen to present content as appearing upright to the user according to the known head orientation.

Thus, block 504 of FIG. 5 shows that once head orientation and device orientation with respect to the head are identified, the device may present the content itself in a content orientation that is maintained with respect to a reference for the content to appear upright in a twelve o′clock orientation on the display relative to the reference (e.g., the user’s head orientation/direction they are facing, line of sight to the device/watch, and/or direction in which their nose points for upright content viewing as determined from head orientation). Thus, the content’s own reference (e.g., the content’s twelve o′clock position) may be aligned with the head reference in the horizontal plane.

Before moving on to block 506 of FIG. 5, further note that the examples above can be combined and used together in any suitable arrangement. For example, input from motion sensors along with input from a camera and/or UWB location tracking may be used as appropriate and possibly for higher-fidelity tracking with a greater level of confidence.

Now note that from block 504 the logic may proceed to decision diamond 506. At diamond 506 the device may determine whether a lock command has been received to lock the current orientation of the content with respect to the orientation of the display. The command may be a verbal command detected via a microphone on the device and voice processing software, or may be another type of command such as, in the present instance, a tap of a finger sensed on the device’s touch-enabled display itself. The tap may be required to be directed to a particular predetermined area of the display (e.g., lower right-hand or left-hand quadrant), an area of the display that is not currently presenting any digital content (e.g., other than a background), or in some instances may be a tap anywhere on the display. A negative determination may cause the logic to revert back to block 500 and continue therefrom to continue rotating content as described above.

However, an affirmative determination may instead cause the logic to proceed to block 508. At block 508 the device may lock or otherwise maintain the current content presentation orientation even if the orientation of the device itself with respect to the user’s head subsequently changes. Thus, the user may use the lock command to lock the particular content that is already being presented (and/or subsequent content that might be also presented) at a particular orientation with respect to the device hardware itself as desired by the user even if the user’s head orientation and/or watch orientation change.

After block 508 the logic may proceed to decision diamond 510. At block 510 the device may determine whether an unlock command has been received, such as another verbal command or another tap at the same or a different predetermined display area. A negative determination may cause the logic to revert back to block 508 and continue to maintain the locked content orientation, while an affirmative determination may cause the logic to proceed back to block 500 again to change content orientation based on subsequent changes of the orientation of the device/watch with respect to the user’s head orientation as described above.

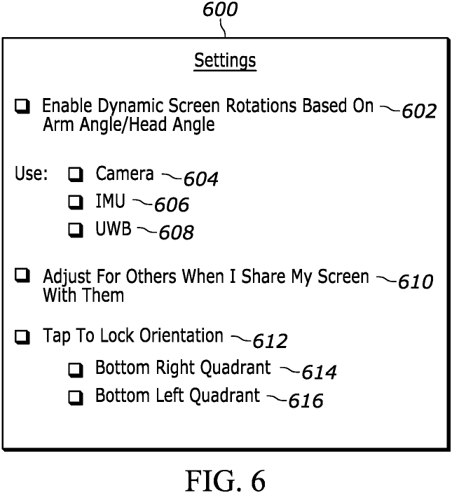

Continuing the detailed description in reference to FIG. 6, it shows an example graphical user interface (GUI) 600 that may be presented on the display of the device undertaking the logic of FIG. 5 (e.g., a smart watch) or the display of a connected device such as a smartphone that has been paired with the smart watch. The GUI 600 may be presented to set or enable one or more settings of the smart watch (or other device) to operate consistent with present principles. For example, the GUI 600 may be reached by navigating a settings menu of the smart watch or associated application on the paired smartphone to configure settings of the watch to operate consistent with present principles. Also note that in the example shown, each option discussed below may be selected by directing touch or cursor input to the respective check box adjacent to the respective option.

As shown in FIG. 6, the GUI 600 may include an option 602 that may be selectable a single time to set or configure the watch/system to perform the functions described herein in multiple future instances, including performing the content rotations described above in reference to FIGS. 3 and 4 as well as to execute the logic of FIG. 5. The GUI 600 may also include options 604-608 to select various respective ways to determine content rotations to perform, such as using camera input as described above (option 604), using motion sensors in an inertial measurement unit as described above (option 606), and using UWB location tracking as described above (option 608).

If desired, in some examples the GUI 600 may also include an option 610 that may be selectable to set or enable the device to rotate content according to the head orientation of non-wearers of the device during times when it might still be worn by the user. This might occur so that, for example, the user may show the watch they are wearing to another person and the content presented on the watch’s display may be rotated according to the head orientation of the other person (e.g., as determined from camera input) even while being worn by the user, so long as the device determines that the watch is oriented toward the other person and not the user themselves.

As also shown in FIG. 6, the GUI 600 may include an option 612. The option 612 may be selected to set or enable the device to detect and act upon screen taps to lock in a certain content orientation as also described above. In some examples, one or more sub-options 614, 616 may also be presented to select various predetermined areas at which to direct the tap to provide a lock command for the device to disambiguate it from other touch inputs. For example, the user may select the bottom right quadrant of the watch/device’s display (option 614) or the bottom left quadrant of the watch/device’s display (option 616).

Moving on from FIG. 6, it is to be further understood consistent with present principles that the actual content that is presented/rotated as described above may also vary based on the positioning of the watch/device with respect to the user’s head orientation as described above. For example, the device may determine that when the watch is held at a specific angle with respect to the user’s head orientation that the user typically requests particular content or a particular content type to be presented (e.g., fitness information, an email inbox, etc.). Once these patterns are learned, the device may predictively present content of a given type to the user based on the angular orientation of the watch itself with respect to the user’s head, so the user does not need to request the corresponding content each time.

To this end, an artificial intelligence (AI) model may be used that has one or more deep neural networks, such as one or more recurrent or convolutional neural networks (e.g., a long short-term memory (LSTM) recurrent network), tailored through machine learning of past datasets of angular orientation and associated contents/content types that are requested, with the contents/types used as labels for training. And being deep neural networks, each neural network may include an input layer, output layer, and multiple hidden layers in between that are configured/weighted to make inferences about an appropriate content/type to select for a given angular orientation input(s). Each ANN may thus be trained through machine learning to tailor the neural network to make content inferences from angular orientation inputs. In some examples, each user request for a given piece of content while the device is at a given angular orientation may be used as a trigger for additional training of the model to further tailor it to the specific user providing the request.

Accordingly, various machine learning techniques may be used, including deep learning techniques. These techniques may include supervised learning, unsupervised learning, semi-supervised learning, reinforcement learning, feature learning, self-learning, and other forms of learning.

Also, before concluding, note for completeness that while in certain examples a watch operating consistent with present principles may have a circular face as described above in reference to FIGS. 3 and 4, the watch face may take other shapes as well, such as rectangular-shaped watch faces.

Also, for completeness, note consistent with the disclosure above that content may also be rotated not just by rotating content within the device’s display itself but, in some examples, by physically rotating the device’s display with respect to other parts of the device using one or more motors to rotate the display about a track on which it is located.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged, or excluded from other embodiments.

1. A smart watch, comprising:
at least one processor;
a display accessible to the at least one processor; and
storage accessible to the at least one processor and comprising instructions executable by the at least one processor to:
identify an orientation of a user’s head;
identify an orientation of the smart watch with respect to the user’s head;
based on the orientation of the user’s head and the orientation of the smart watch resulting in a first angular position of the smart watch with respect to the orientation of the user’s head, present first content on the display in a content orientation that is maintained with respect to a reference for the first content to appear upright on the display relative to the reference; and
based on the orientation of the user’s head and the orientation of the smart watch resulting in a second angular position of the smart watch with respect to the orientation of the user’s head, present second content on the display in the content orientation that is maintained with respect to the reference for the second content to appear upright on the display relative to the reference, wherein the second angular position is different from the first angular position, and wherein the second content is different from the first content.

2. The smart watch of claim 1, wherein the reference is the user’s line of sight to the display as determined from the orientation of the user’s head, and wherein the content orientation is a twelve o′clock orientation with respect to the user’s line of sight.

3. The smart watch of claim 1, comprising a camera accessible to the at least one processor, and wherein the instructions are executable to:
receive input from the camera; and
identify the orientation of the user’s head based on the input from the camera.

4. The smart watch of claim 3, wherein the instructions are executable to:
based on the input from the camera, identify an orientation of a body part of the user besides the user’s head, the body part comprising one or more of: the user’s neck, the user’s torso, a shoulder of the user; and
deduce the orientation of the user’s head based on the orientation of the body part.

5. The smart watch of claim 3, wherein the instructions are executable to:
based on the input from the camera, identify the orientation of the smart watch.

6. The smart watch of claim 1, comprising at least one motion sensor accessible to the at least one processor, wherein the instructions are executable to:
based on input from the at least one motion sensor, identify the orientation of the user’s head.

7. The smart watch of claim 6, wherein the instructions are executable to:
based on input from the at least one motion sensor, identify movement of the smart watch; and
based on the movement of the smart watch, identify the orientation of the user’s head.

8. The smart watch of claim 6, wherein the instructions are executable to:
based on input from the at least one motion sensor, identify an activity of the user; and
based on the activity of the user, identify the orientation of the user’s head.

9. The smart watch of claim 1, comprising an ultra-wideband (UWB) transceiver accessible to the at least one processor, wherein the instructions are executable to:
use the UWB transceiver to receive one or more first UWB signals from a device different from the smart watch; and
identify the orientation of the user’s head based on UWB location tracking that is executed using the one or more first UWB signals.

10. The smart watch of claim 9, wherein the instructions are executable to:
use the UWB transceiver to receive one or more second UWB signals from the device; and
identify the orientation of the smart watch based UWB location tracking that is executed using on the one or more second UWB signals.

11. The smart watch of claim 10, wherein the one or more second UWB signals are different from the one or more first UWB signals.

12. A method, comprising:
identifying an orientation of a user’s head;
based on the orientation of the user’s head resulting in a first angular position of a device with respect to the orientation of the user’s head, predictively presenting first content on a display of the device in a content orientation that is maintained with respect to a reference for the first content to appear upright on the display relative to the reference; and
based on the orientation of the user’s head resulting in a second angular position of the device with respect to the orientation of the user’s head, predictively presenting second content on the display in the content orientation that is maintained with respect to the reference for the second content to appear upright on the display relative to the reference, wherein the second angular position is different from the first angular position, and wherein the second content is different from the first content.

13. (canceled)

14. The method of claim 12, wherein the reference is a direction in which the user’s face is oriented as determined from the orientation of the user’s head, and wherein the content orientation is a twelve o′clock orientation with respect to the direction in which the user’s face is oriented.

15. (canceled)

16. A device, comprising:
a housing;
a display on the housing and configured to electronically presentcontent;
an orientation sensor configured to sense an angular orientation of the housing; and
at least one processor programmed with instructions to:
based on first signals from the orientation sensor indicating a first angular orientation of the device with respect to a reference, present first content on the display in a content orientation that is maintained with respect to the reference for the first content to appear upright on the display relative to the reference; and
based on second signals from the orientation sensor indicating a second orientation of the device with respect to the reference, present second content on the display in the content orientation that is maintained with respect to the reference for the second content to appear upright on the display relative to the reference, wherein the second angular orientation is different from the first angular orientation, and wherein the second content is different from the first content.

17. The device of claim 16, wherein the instructions are executable to maintain the content orientation as the housing turns.

18. (canceled)

19. The device of claim 16, wherein the reference comprises a location of a user of the device.

20. (canceled)

21. The smart watch of claim 1, wherein the first angular position is associated with a first content type, wherein the first content is selected for presentation on the display based on the first content being associated with the first content type, wherein the second angular position is associated with a second content type different from the first content type, and wherein the second content is selected for presentation on the display based on the second content being associated with the second content type.

22. The smart watch of claim 21, wherein the first angular position is determined to be associated with the first content type based on a first output from at least one artificial neural network (ANN) trained through machine learning, and wherein the second angular position is determined to be associated with the second content type based on a second output from the at least one ANN.

23. The smart watch of claim 1, wherein the first angular position is associated with the first content such that the first content is selected for presentation on the display based on the first content being associated with the first angular position, and wherein the second angular position is associated with the second content such that the second content is selected for presentation on the display based on the second content being associated with the second angular position.

24. The smart watch of claim 23, wherein the first angular position is determined to be associated with the first content based on a first output from at least one artificial neural network (ANN) trained through machine learning, and wherein the second angular position is determined to be associated with the second content based on a second output from the at least one ANN.
